(19) United States
(12) Patent Application Publication
(10) Pub. No.: US 2002/0191271 A1
(43) Pub. Date: Dec. 19, 2002

(54) Generic optical modulator

(76) Inventor: Michael H. Myers, Poway, CA (US)

Correspondence Address: ALL OPTICAL NETWORKS, INC., 9440 CARROLL PARK DRIVE, SAN DIEGO, CA, 92121, US

(21) Appl. No.: 10/155,101

(22) Filed: May 23, 2002

Related U.S. Application Data
(60) Provisional application No. 60/292,897, filed on May 23, 2001.

(51) Int. Cl. G02F 1/01

(52) U.S. Cl. 359/279

(57) ABSTRACT

A generic optical modulator includes a first inteferometer receiving a first control signal and a second interferometer receiving a second control signal, and each receive a portion of an incoming light signal. The output of the first interferometer is attached to the output of the second interferometer after that output has passed through a phase shifter. A coupler receives the output of the first interferometer and the second interferometer and generates a modulated signal therefrom.

### RELATED APPLICATIONS

The present application claims the benefit of priority from United States Provisional Application Serial No. 60/292,897 filed May 23, 2001, currently co-pending, and which is fully incorporated herein by this reference.

### BACKGROUND OF THE INVENTION

Commercial light modulators, on-off keying, commercial QPSK modulators (i.e., single function modulators) are currently available. These devices, however, are limited only to a particular type of modulation.

### SUMMARY OF THE INVENTION

A single device is capable of producing any modulation type desired on light, including but not limited to, the following listed modulation types:

1. AM-D5B

2. FM

3. FSK

4. M-ary FSK

5. Coherent FSK

6. MSK and Walsh Modulated MSK (for CDMA)

7. Binary PSK and M-ary PSK

8. QAM (quadrature amplitude modulation)

9. Pure Frequency Shift

10. Correct Laser Frequency for all types 1-9; and

11. Optical Differentiator.

The advantages of the present invention include the ability to implement a multi-function light transmitter, as well as perform wavelocking. The device may be implemented in polymers to be significantly cheaper than existing devices, and much more versatile.

### DESCRIPTION OF THE DRAWINGS

FIG. 1 provides an overview of the present invention, and includes a first inteferometer receiving a first control signal and an output, a second interferometer receiving a second control signal and an output. The first inteferometer and the second interferometer each receive a portion of an incoming light signal. A phase shifter is attached to the output of the second inteferometer and a coupler receiving the output of said first interferometer and said second interferometer and generating a modulated signal therefrom.

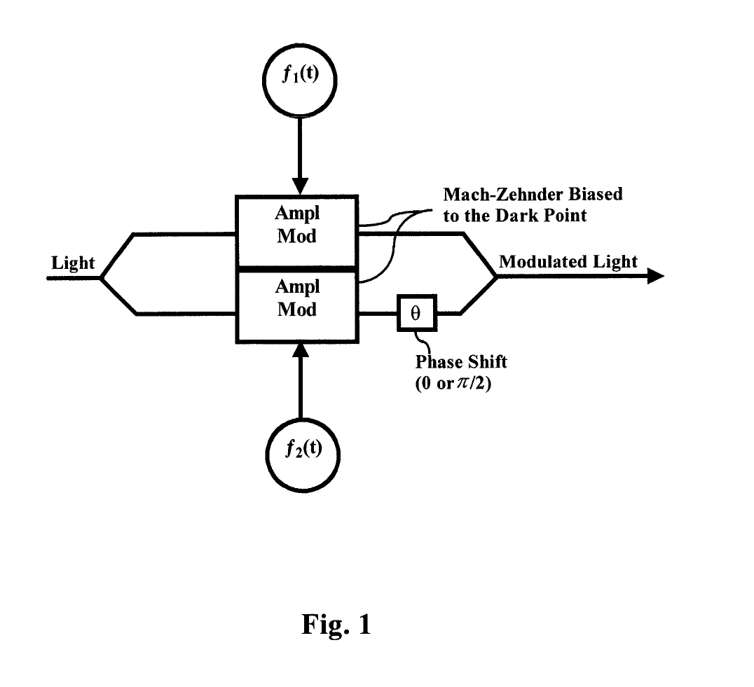

1. A generic optical modulator comprising:
a first inteferometer receiving a first control signal and an output;
a second interferometer receiving a second control signal and an output, wherein said first inteferometer and said second interferometer each receive a portion of an incoming light signal;
a phase shifter attached to said output of said second inteferometer; and
a coupler receiving the output of said first interferometer and said second interferometer and generating a modulated signal therefrom.
